(19) United States
(12) Patent Application Publication
(10) Pub. No.: US 2007/0077112 A1
(43) Pub. Date: Apr. 5, 2007

(54) Single-use nail varnish applicator

(76) Inventor: Elisa Abigail Santamaria, (US)

Correspondence Address: THE MARTINEZ GROUP PLLC;Mark Sgantzos, Suite 323, 55 Washington Street (Dumbo), Brooklyn, NY, 11201-1070, US

(21) Appl. No.: 11/601,926

(22) Filed: Nov. 20, 2006

(30) Foreign Application Priority Data
Jan. 29, 2003 (ES) 200300209

(51) Int. Cl. B05C 1/00

(52) U.S. Cl. 401/17

(57) ABSTRACT

A single-use nail varnish applicator having an empty body and two compartments, a larger one containing the nail varnish and another smaller one for containing a corrector product, such as acetone, having two necks, one at each end of the body, in each one of which there is a brush in communication with its corresponding compartment, with the assembly being sealable with caps to close the compartments and protect the brushes.

### OBJECT OF THE INVENTION

The invention refers to single-use nail varnish, comprising an empty body with any configuration in which there are two compartments, a larger one containing the nail varnish and another smaller one for containing a corrector product, such as acetone or similar product, incorporating two necks one at each end of the body, in each one of which there is a brush in communication with its corresponding compartment, with the assembly being completed with caps to close the compartments and protect the brushes.

The object of the invention is to provide single-use nail varnish which can be used easily, quickly and comfortably, the obvious purpose of which is to enable nails to be varnished in any place or situation and at any time, with the empty container subsequently being discarded.

### BACKGROUND OF THE INVENTION

Nail varnish bottles are normally of a size that allows a sufficient quantity of varnish to be stored for the varnishing of nails on several occasions until the varnish had been used up. Normally, these nail varnish bottles have a stopper incorporating a rod with a brush on the end with which the nail varnishing operation is carried out.

The disadvantage of these conventional nail varnish bottles is that they require a quiet place in which to use them and that the process has to be completed with another separate bottle containing the corrector product.

Consequently, although at times women carry in their handbags nail varnish and the corrector product, it is difficult to use them because a quiet place and the right moment have to be found for carrying out this operation.

To the foregoing complication has to be added the problem of volume and the nuisance involved in carrying in a handbag two bottles or containers, one for the varnish and the other for the corrector product.

### SUMMARY OF THE INVENTION

The nail varnish applicator of the instant invention, has been conceived to solve the foregoing problems, based on a simple but effective solution, in which a small-sized container incorporates both the means for the nail painting operation with varnish, and the means for correcting any imperfections that may have occurred during the nail varnishing operation or for removing the varnish, with corrector product, all of which forms a single body of reduced dimensions. The body presents the particularity of having an internal separating wall which divides the body into two compartments each with a different capacity, a larger one for the nail varnish and a smaller one for containing the corrector product, whether acetone or another similar product, which has been designed in such a way that at the end of each compartment there is a neck into which is fitted a small stopper or protective cap, similar to the top of a ball-point pen, and this stopper or cap provided at each one of the ends will protect a brush, which in one case will be used to apply the corrector product and in the other to apply the nail varnish. The brush provided at one of the ends, specifically at the end of the neck corresponding to the smaller compartment has the shape of a cannula or similar, made of absorbent and compact material, which can be impregnated with and can absorb the corrector product whereas the brush provided at the other end, that is, at the end of the neck corresponding to the larger compartment is associated with a spring which, when pressed inside with axial displacement, allows the produce to come out, impregnating the brush. This has the particularity that this end corresponding to the neck of the larger compartment has two walls, an inside wall and external wall, with a gap between them which can be compressed and when, for example, the brush is forced inside as a result of being pressed against the nail to be varnished, the displacement inside against the spring produces a reduction in the volume of the cavity which pushes out a quantity of nail varnish.

The nail varnish container can be safely carried in a handbag and its use easy and comfortable allowing the nail varnishing operation to be carried out in the train, on a bus, at the swimming pool, or in any place and at any time that may be necessary, providing, in short, a medium for the instantaneous and fast varnishing of nails, in no way constituting a nuisance because it is for a single use.

### BRIEF DESCRIPTION OF THE DRAWINGS

The singe use nail varnish applicator of the present invention being described herein is described as follows, reference being made to the drawings wherein:

FIG. 1 shows a general view of the preferred embodiment of the single-use nail varnish container showing the stoppers or protective caps off the container.

FIG. 2 shows a general view of the preferred embodiment of the single-use nail varnish container with the caps fitted to the corresponding necks at each end of the body of the applicator.

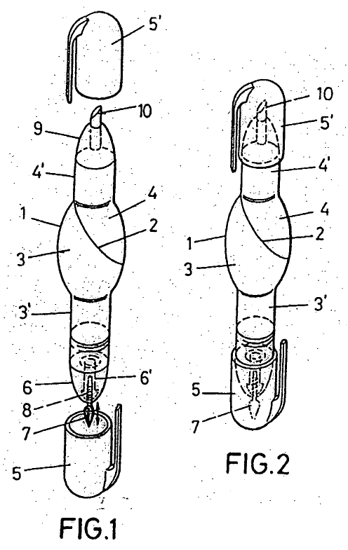

### DETAILED DESCRIPTION OF THE INVENTION

From the figures referred to above, the nail varnish container of the instant invention is made up of an empty body which, in the form of the implementation represented, has a convex shape and adopts a configuration similar to that of a ball-point pen, without ruling out the possibility of it having any other shape or configuration, always of small dimensions and equipped inside with a wall (2) forming two compartments (3) and (4), the first of which has the largest volume and the second has smaller dimensions or capacity, in such a way that both compartments continue as far as their corresponding necks (3¹) and (4¹), to which are fitted their corresponding stoppers or caps (5) (5¹), similar to the top of a ball-point pen, as in the example represented. The larger compartment (3) has been designed to contain the nail varnish, where the smaller compartment (4) has been designed to contain the corrector product (acetone or a similar product). A conical piece (6) has been provided at the end of the neck (3¹) of compartment (3) to contain a brush (7), which sticks out and which can be displaced by pressing against a spring (8) situated inside, so that, by pressing with the brush (7) against the nail to be varnished, allows the varnish contained in the deposit or compartment (3) to come out. The conical piece (6) fitted to the end of the neck (3¹) of compartment (3) has two walls, an external wall corresponding to the conical piece (6) itself and an internal wall (6¹) forming between them a narrow stretch in which is situated the spring (8), the narrowing of which, when compressed, forces the brush (7) to protrude, with a part by way of a rod around which the spring (8) is housed inside the internal wall (6¹) of the conical part (6), all of which has the aforesaid functionality, that is, to allow the nail varnish contained in compartment (3) to come out when the brush (6) is axially pressed against the action of the spring or retractile element (8), due to the fact that the compressed air in the cavity between walls (6) and (6¹) forces the ejection of the liquid part, that is, the product corresponding to the nail varnish. At the same time, at the end of neck (4¹) corresponding to the smaller compartment (4), a conical part has been provided (9) in which a cannula (10) has been inserted, with the function of a brush, capable of being impregnated with and absorbing the corrector product contained in compartment (4), through which cannula (10) and, of course, the product with which it is impregnated, it is possible to remove the nail varnish or even correct any imperfections that may have arisen in the application of the nail varnish. The spring or retractile element (8) is housed in the narrow stretch defined by the end of the conical part (6) provided in the neck (3¹) of compartment (3), which narrowing occurs between both walls (6) and (6¹) of the conical part of the neck (3¹).

1. A single-use nail varnish applicator, comprising a container having an internal wall defining two independent compartments, the first compartment is sized to contain nail varnish and the second compartment having reduced dimensions relative to the first compartment to contain a varnish corrector product, wherein both compartments extend into open ended necks at opposite ends of the container, one of which has a brush at its end for painting nails with varnish and the other of which has a brush for applying the corrector product, the necks being sealable with protective caps.

2. The single-use nail varnish applicator of claim 1, wherein the brush provided at the end of the neck corresponding to the first compartment contains a spring located and retained in a narrow stretch defined by two concentric walls, wherein the brush is conically shaped.

3. The single-use nail varnish applicator of claim 1, wherein the brush corresponding to the neck of the smaller compartment is comprised of a cannula which is capable of absorbing the varnish corrector product, wherein the cannula is inserted in the end of a conical part fitted over the neck of the second compartment.
